(19) United States
(12) Patent Application Publication
(10) Pub. No.: US 2018/0236409 A1
(43) Pub. Date: Aug. 23, 2018

(54) PERMSELECTIVE MEMBRANE AND METHOD FOR PRODUCING THE SAME

(71) Applicants: KURITA WATER INDUSTRIES LTD., Tokyo (JP); NATIONAL UNIVERSITY CORPORATION KOBE UNIVERSITY, Kobe-shi, Hyogo (JP)

(72) Inventors: Akihiro FUJII, Tokyo (JP); Takahiro KAWAKATSU, Tokyo (JP); Hideto MATSUYAMA, Kobe-shi, Hyogo (JP); Daisuke SAEKI, Kobe-shi, Hyogo (JP); Fumiya SAKO, Kobe-shi, Hyogo (JP)

(21) Appl. No.: 15/554,616

(22) PCT Filed: Feb. 17, 2016
(86) PCT No.: PCT/JP2016/054523

§ 371 Date: Aug. 30, 2017

(30) Foreign Application Priority Data
Mar. 4, 2015 (JP) 2015-042528

(51) Int. Cl. B01D 67/00; B01D 71/02; B01D 71/06; B01D 69/12; C02F 1/44

(52) U.S. Cl. CPC B01D 67/0088; B01D 71/025; C02F 1/44; B01D 69/12; B01D 71/06

(57) ABSTRACT

To provide a permselective membrane that includes a coating layer constituted by a phospholipid bilayer, the coating layer being capable of withstanding the pressure applied during a water treatment and being resistant to detachment and a method for producing the permselective membrane. A permselective membrane comprising a membrane main body having permselectivity and a coating layer disposed on a surface of the membrane main body, the coating layer including a phospholipid bilayer including a channel substance, wherein the phospholipid bilayer includes phospholipids that are a first phospholipid including an acyl group constituted by a fatty acid including an unsaturated fatty acid and a second phospholipid including two acyl groups each constituted by a fatty acid that is a saturated fatty acid having 16 to 24 carbon atoms.

### TECHNICAL FIELD

The present invention relates to a permselective membrane used in a field of water treatment and a method for producing the permselective membrane and particularly to a permselective membrane including a coating layer constituted by a phospholipid bilayer and a method for producing the permselective membrane.

### BACKGROUND ART

Reverse osmosis (RO) membranes have been widely used as permselective membranes in fields of desalination of seawater and salt water, production of industrial water and ultrapure water, wastewater recovery, and the like. An RO-membrane treatment advantageously enables a high degree of rejection of ions and low-molecular organic substances. An RO-membrane treatment requires a higher operating pressure than treatments in which a microfiltration (MF) membrane or an ultrafiltration (UF) membrane is used. Attempts have been made to enhance permeability of RO membranes. For example, an attempt has been made to increase a surface area of a polyamide RO membrane by controlling wrinkled structure of a skin layer.

RO membranes become contaminated with organic substances such as the metabolites of living organisms contained in water that is to be treated. Since a contaminated membrane has low permeability, RO membranes need to be chemically cleaned on a regular basis. Subjecting an RO membrane to chemical cleaning degrades the membrane and reduces the separation performance of the membrane.

One of the known methods for reducing membrane contamination is to cover a permselective membrane, such as an RO membrane, with a phospholipid bilayer including a channel substance. When a permselective membrane is covered with a phospholipid bilayer, a biomimetic surface is formed on the permselective membrane. This may prevent the permselective membrane from becoming contaminated with the metabolites of living organisms.

As water-channel substances, attention has been given to aquaporins, which are membrane proteins that selectively transport water molecules. It has been suggested that a phospholipid bilayer including this protein may have theoretically higher permeability than a conventional polyamide RO membranes used in the related art (Non Patent Literature 1).

For producing a permselective membrane including a phospholipid bilayer including a water-channel substance, the following methods have been proposed: a method in which a lipid bilayer including a water-channel substance is sandwiched between porous substrates; a method in which a lipid bilayer is formed inside the pores of a porous substrate; and a method in which a lipid bilayer is formed on the periphery of a hydrophobic membrane (Patent Literature 1).

Although the method in which a phospholipid bilayer is sandwiched between porous substrates enhances the pressure resistance of the phospholipid bilayer, the porous substrates may become contaminated since they are brought into contact with water that is to be treated. Furthermore, concentration polarization may occur in the porous substrates, which significantly reduces the rejection of the permselective membrane. In addition, the porous substrates may act as resistance and degrade the permeability of the permselective membrane.

When an RO membrane is formed by covering the surface of a membrane main body having permselectivity with a phospholipid bilayer including a water-channel substance, the phospholipid bilayer serving as a separation layer while being exposed to water that is to be treated, the phospholipid bilayer has low pressure resistance. Since the phospholipid bilayer is brought into direct contact with water that is to be treated, the phospholipid bilayer may easily detach from the membrane main body.

Although it is described in Patent Literature 2 that a phospholipid bilayer can be firmly deposited on a nanofiltration membrane by using a cationic phospholipid, a technique in which a phospholipid including a fatty acid that is a saturated fatty acid and a phospholipid including a fatty acid that is an unsaturated fatty acid are used in combination is not described in Patent Literature 2.

It is known that, with an increase in temperature, a phospholipid bilayer undergoes a phase transition from the gel phase in which phospholipids have low fluidity into the liquid-crystal phase in which phospholipids have high fluidity (Non Patent Literature 2). The temperature at which the above phase-transition occurs is referred to as “phase-transition temperature”. It has been reported that, when two types of phospholipids having different phase-transition temperatures are used as phospholipids constituting a phospholipid bilayer, the phospholipid bilayer undergoes a phase separation into the gel phase and the liquid-crystal phase (Non Patent Literature 3).
Patent Literature 1: Japanese Patent No. 5616396
Patent Literature 2: JP2014-100645A
Non Patent Literature 1: Pohl, P et al., Proceedings of the National Academy of Sciences 2001, 98, 9624-9629.
Non Patent Literature 2: Shoshichi Nojima et al., Liposome, (1988), Nankodo
Non Patent Literature 3: J. A. Svetlovics et al., Biophysical Journal, 2012, 102, 2526-2535.

As described above, at a temperature higher than the phase-transition temperature, a phospholipid bilayer undergoes a phase transition from the gel phase in which phospholipids have low fluidity into the liquid-crystal phase in which phospholipids have high fluidity.

In the case where a phospholipid bilayer that covers a membrane main body is constituted by only a phospholipid having a phase-transition temperature lower than the temperature of water that is to be treated, the entirety of the phospholipid bilayer undergoes a phase transition into the liquid-crystal phase when a water treatment is performed. Since the liquid-crystal phase has high fluidity, detachment and fracture of the phospholipid bilayer occur easily.

### SUMMARY OF INVENTION

An object of the present invention is to provide a permselective membrane that includes a coating layer constituted by a phospholipid bilayer, the coating layer being capable of withstanding the pressure applied during a water treatment and being resistant to detachment and a method for producing the permselective membrane.

The permselective membrane of the present invention comprises a membrane main body having permselectivity and a coating layer disposed on a surface of the membrane main body. The coating layer includes a phospholipid bilayer including a channel substance. The phospholipid bilayer includes phospholipids that are a first phospholipid including an acyl group constituted by a fatty acid including an unsaturated fatty acid and a second phospholipid including two acyl groups each constituted by a fatty acid that is a saturated fatty acid having 16 to 24 carbon atoms.

The method for producing a permselective membrane of the present invention comprises bringing a phospholipid-containing liquid containing phospholipids and a channel substance into contact with a membrane main body in order to form a coating layer including a phospholipid bilayer on a surface of the membrane main body. The phospholipid-containing liquid contains a first phospholipid including an acyl group constituted by a fatty acid including an unsaturated fatty acid and a second phospholipid including two acyl groups each constituted by a fatty acid that is a saturated fatty acid having 16 to 24 carbon atoms.

The channel substance is not limited; any channel substance capable of forming micropores in the phospholipid bilayer, thereby forming channels that facilitate the permeation of water, may be used. Examples of the channel substance include gramicidin and amphotericin B.

The membrane main body may be an MF membrane, a UF membrane, an RO membrane, or an NF membrane. Among the above membranes, in particular, an MF membrane and a UF membrane are preferable. In the present invention, the permselective membrane is not limited to an RO membrane and may be a forward osmosis membrane (FO membrane).

### ADVANTAGEOUS EFFECTS OF INVENTION

The inventors of the present invention found that a permselective membrane has high pressure resistance, when a first phospholipid including an acyl group including an unsaturated fatty acid and a second phospholipid including two acyl groups each constituted by a saturated fatty acid having 16 to 24 carbon atoms are used as phospholipids constituting a phospholipid bilayer.

As described in Non Patent Literature 3 above, the phospholipid bilayer undergoes a phase separation into the gel phase and the liquid-crystal phase, when two types of phospholipids having different phase-transition temperatures are used as phospholipids constituting a phospholipid bilayer.

When a first phospholipid including an acyl group including an unsaturated fatty acid and a second phospholipid including two acyl groups each constituted by a saturated fatty acid having 16 or more carbon atoms are included in a phospholipid bilayer, the phospholipid bilayer undergoes a phase separation into the gel phase and the liquid-crystal phase. This reduces the fluidity of the phospholipids constituting the phospholipid bilayer. As a result, the phospholipid bilayer of the permaselective membrane has sufficiently high pressure resistance.

In a phospholipid bilayer constituted by only a phospholipid including two acyl groups each constituted by a saturated fatty acid having 16 or more carbon atoms, gramicidin A, which serves as a channel substance, fails to form a channel structure. Using the first phospholipid having a phase-transition temperature lower than the temperature of water that is to be treated in combination with the second phospholipid including two acyl groups each constituted by a saturated fatty acid having 16 or more carbon atoms enables both an increase in permeability as a result of gramicidin A forming a channel structure and an increase in the pressure resistance of the phospholipid bilayer.

### BRIEF DESCRIPTION OF DRAWINGS

FIG. 1 is a schematic diagram illustrating an experimental facility.

FIG. 2 is a CD spectrum of a membrane.

FIG. 3 is a CD spectrum of a membrane.

### DESCRIPTION OF EMBODIMENTS

In the present invention, a phospholipid-containing liquid containing a first phospholipid including an acyl group including an unsaturated fatty acid and a second phospholipid including two acyl groups each constituted by a saturated fatty acid having 16 to 24 carbon atoms is brought into contact with a membrane main body having permselectivity in order to form a coating layer including a phospholipid bilayer on the surface of the membrane main body.

[Membrane Main Body]

The membrane main body may be an NF membrane, a UF membrane, an RO membrane, or an MF membrane. The material for the membrane is preferably, but not limited to, cellulose, polyethersulfone, or alumina.

The surface of the membrane main body is preferably subjected to a silane coupling treatment in order to increase the adhesion of the phospholipid bilayer to the membrane main body. The silane coupling treatment may be performed by, for example, immersing the membrane main body in a solution of a silane coupling agent. It is preferable to subject the surface of the membrane main body to a plasma treatment prior to the silane coupling treatment in order to make the surface of the membrane main body hydrophilic.

[Phospholipid]

Examples of the first phospholipid including an acyl group constituted by a fatty acid including an unsaturated fatty acid, that is, an acyl group including a residue of an unsaturated fatty acid, include 1-palmitoyl-2-oleoyl-sn-glycero-3-phosphocholine (POPC), 1,2-dioleoyl-sn-glycero-3-phosphocholine, 1,2-dioleoyl-sn-glycero-3-phosphoethanolamine, 1,2-dioleoyl-sn-glycero-3-phospho-L-serine, 1,2-dioleoyl-sn-glycero-3-phospho-rac-(1-glycerol), egg-yolk phosphatidylcholine, and soybean phosphatidylcholine.

The second phospholipid including two acyl groups each constituted by a fatty acid that is a saturated fatty acid having 16 to 24 carbon atoms, that is, two acyl groups each constituted by a residue of a saturated fatty acid having 16 or more carbon atoms, desirably has a phase-transition temperature of 40° C. to 80° C. Examples of the second phospholipid include 1,2-dipalmitoyl-sn-glycero-3-phosphocholine (DPPC), 1, 2-diheptadecanoyl-sn-glycero-3-phosphocholine, 1,2-distean ROyl-sn-glycero-3-phosphocholine, 1,2-dinonadecanoyl-sn-glycero-3-phosphocholine, 1,2-diarachidoyl-sn-glycero-3-phosphocholine, 1,2-dibehenoyl-sn-glycero-3-phosphocholine, 1,2-ditricosanoyl-sn-glycero-3-phosphocholine, 1,2-dilignoceroyl-sn-glycero-3-phosphocholine, 1,2-dipalmitoyl-sn-glycero-3-phosphoethanolamine, 1,2-dipalmitoyl-sn-glycero-3-phospho-L-serine, 1,2-dipalmitoyl-sn-glycero-3-phospho-rac-(1-glycerol), hydrogenated egg-yolk phosphatidylcholine, and hydrogenated soybean phosphatidylcholine. Among the above phospholipids, in particular, 1,2-dipalmitoyl-sn-glycero-3-phosphocholine and 1,2-distean ROyl-sn-glycero-3-phosphocholine are preferable.

The ratio of the amount of the second phospholipid including two acyl groups each constituted by a saturated fatty acid having 16 or more carbon atoms to the total amount of first phospholipid and second phospholipid is preferably 20 to 80 mol %.

[Channel Substance]

Examples of the channel substance include gramicidins (e.g., gramicidin A) and amphotericin B.

[Method for Depositing Phospholipid Bilayer]

For covering the surface of the membrane main body with a phospholipid bilayer, the Langmuir-Blodgett technique or a vesicle fusion method may be used.

To form a phospholipid bilayer by a vesicle fusion method, the phospholipids are dissolved in a solvent, preferably with the channel substance. Examples of the solvent include chloroform and a chloroform/methanol mixture.

It is preferable to set the mixing ratio among the first and second phospholipids and the channel substance such that the ratio of the amount of channel substance to the total amount of the first and second phospholipids and the channel substance is 1% to 20% by mole or is particularly 3% to 10% by mole.

A solution containing the phospholipids and the channel substance at a concentration of 0.25 to 10 mM or particularly at a concentration of 0.5 to 5 mM is prepared. Subsequently, drying is performed under a reduced pressure in order to form dry lipid membranes. Pure water is added to the dry lipid membranes, and the resulting mixture is heated to a temperature higher than the phase-transition temperatures of the phospholipids. Hereby, a dispersion containing spherical-shell-shaped vesicles is prepared.

In an embodiment of the present invention, the vesicle dispersion is filtered through a membrane (e.g., a polycarbonate track-etched membrane) having pores with a size of 0.05 to 0.8 μm to form a dispersion containing spherical-shell-shaped vesicles having a size of 0.05 to 0.8 μm or less. The vesicle dispersion is then subjected to a freezing and thawing method, in which the vesicle dispersion is held at a temperature higher than the phase-transition temperatures of the phospholipids and at a temperature equal to or lower than the freezing temperature alternately, in order to grow the spherical-shell-shaped vesicles such that the average size of the vesicles reaches 0.5 to 5 μm.

In another embodiment of the present invention, the vesicle dispersion is directly used without being subjected to the above freezing and thawing treatment.

The average size of the vesicles contained in the vesicle dispersion used in the present invention is preferably 0.5 to 5 μm and is particularly preferably 1 to 5 μm. The vesicle dispersion may contain vesicles having an average size of less than 0.5 μm (e.g., size of 0.1 to 0.5 μm). Adding vesicles having such a small size to the vesicle dispersion enables a dense membrane to be formed. In order to form a dense membrane, it is preferable that the vesicles contained in the vesicle dispersion have a particle size distribution such that the 25%-cumulative value of scattering intensity measured by a dynamic light scattering method is 0.5 μm or more, and the 75%-cumulative value of scattering intensity is 5 μm or less.

After the vesicle dispersion has been brought into contact with the membrane main body, the membrane main body is kept in contact with the vesicle dispersion for about 0.5 to 6 Hr or particularly for about 1 to 3 Hr such that the vesicles are adsorbed onto the surface of the membrane main body. Thus, the coating layer constituted by the phospholipid bilayer is formed. Then, the membrane main body including the coating layer deposited thereon is withdrawn from the solution. The main body thus withdrawn may be washed with ultrapure water or pure water. Hereby, the permselective membrane including the coating layer constituted by the phospholipid bilayer is produced.

The coating layer preferably consists of 1 to 30 layers particularly 1 to 15 layers. An anionic substance, such as polyacrylic acid, polystyrene sulfonic acid, or tannic acid, may be optionally adsorbed on the surface of the coating layer.

When permeate is produced by a reverse-osmosis membrane treatment or a forward-osmosis membrane treatment with the permselective membrane according to the present invention, a quantity of permeate of 1×10⁻¹¹ m³m⁻²s⁻¹Pa⁻¹ or more can be achieved at a driving pressure of 0.05 to 3 MPa.

The permselective membrane according to the present invention may be used for various fields including desalination of seawater and salt water; purification of industrial water, sewage, and tap water; and concentration of fine chemicals, drugs, and foods. A temperature of water that is to be treated by the membrane is preferably about 10° C. to 40° C. and is particularly preferably about 15° C. to 35° C.

### EXAMPLES

Examples and Comparative examples are described below. The materials, evaluation methods, etc. used in Examples and Comparative examples are described below.

[Membrane Main Body]

The membrane main body used in Examples and Comparative examples below was an anodic-oxidation alumina film (Anodisc produced by Whatmann, diameter: 25 mm, pore size: 20 nm).

[Phospholipids]

As a first phospholipid including an acyl group including an unsaturated fatty acid, 1-palmitoyl-2-oleoyl-sn-glycero-3-phosphocholine (POPC, phase-transition temperature: −2° C., produced by NOF CORPORATION) was used.

As a second phospholipid including two acyl groups each constituted by a saturated fatty acid having 16 carbon atoms, 1,2-dipalmitoyl-sn-glycero-3-phosphocholine (DPPC, phase-transition temperature: 41° C., produced by NOF CORPORATION) was used.

[Channel Substance]

As a channel substance, gramicidin A (GA, produced by Sigma-Aldrich) was used.

[Silane Coupling Treatment of Membrane Main Body]

Before the membrane main body was covered with a phospholipid bilayer, the membrane main body was subjected to a silane coupling treatment with a silane coupling agent (octadecyltrichlorosilane (produced by Sigma-Aldrich)) in the following manner.

First, the membrane main body was immersed in pure water and ultrasonically cleaned for five minutes. The membrane main body was subsequently subjected to a plasma treatment with a tabletop vacuum-plasma apparatus (YHS-R, produced by SAKIGAKE-Semiconductor Co., Ltd.) in order to make the surface of the membrane main body hydrophilic. After the membrane main body had been immersed in a 2-vol % toluene solution of octadecyltrichlorosilane for 15 minutes, it was washed with toluene and pure water. Subsequently, the membrane main body was left to stand at room temperature through the night.

[Method for Confirming Formation of Channels by Channel Substance]

For confirming whether the channel substance introduced in the phospholipid bilayer served as a water-channel substance, the circular dichroism (CD) spectrum of a vesicle dispersion having the same composition as the phospholipid bilayer covering the surface of the membrane main body was measured with a circular dichroism spectrophotometer (J-725K, produced by JASCO Corporation).

It is known that, when gramicidin A serves as a channel substance, positive peaks of the spectrum occur at 218 nm and 235 nm and a valley of the spectrum occurs at 230 nm (S. S. Rawat et al., Biophysical Journal, 2004, 87, 831-843).

[Method for Evaluating Performance of Permselective Membrane]

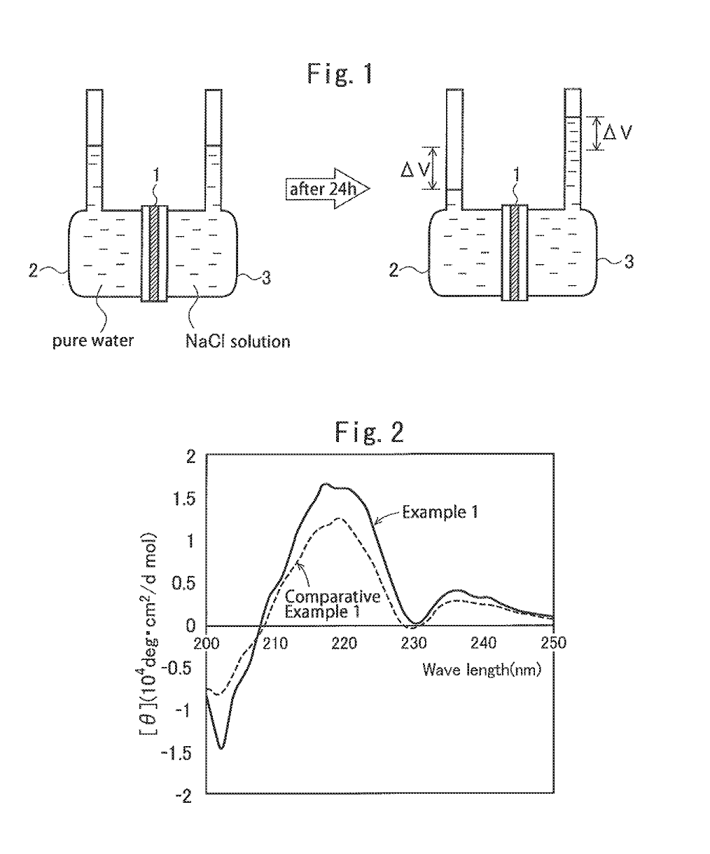

FIG. 1 illustrates an apparatus for evaluating the performance of the membrane. A membrane 1 was attached to a flat-membrane cell. Pure water was charged into a container 2, which was separated from another container 3 with the membrane 1. An aqueous sodium chloride solution was charged into the other container 3. Under conditions where the concentration of the aqueous sodium chloride solution was 3.0 wt % such that the difference in osmotic pressure was 3 MPa, the salt leakage of the membrane was determined at a driving pressure of 3 MPa. The solutions contained in the containers 2 and 3 were each stirred with a magnetic stirrer. After a lapse of 24 hours, the electric conductivity of each of the solutions was measured. The NaCl concentration in each solution was determined on the basis of the electric conductivity of the solution. The salt leakage was calculated using the Formula (1) below:

Salt leakage (%)=(C/Cref)×100% (1)

Where C represents a NaCl concentration (g/L) measured on the pure-water side after the lapse of 24 hours; and Cref represents a sodium chloride concentration (g/L) measured on the aqueous-sodium-chloride-solution side after the lapse of 24 hours.

A quantity of permeate permeating the permaselective membrane at a driving pressure of 0.1 MPa was measured under conditions where the concentration of the aqueous sodium chloride solution was 0.1 wt %, and the difference in osmotic pressure was 0.1 MPa. The quantity of permeate was calculated using Formula (2) below on the basis of the change in water level ΔV (m³), the area of the membrane S (m²), time t (s), and the initial difference in osmotic pressure ΔP (Pa):

Quantity of permeate{m³/(m²·sPa)}=ΔV/S·t·ΔP (2)

Reference examples 1 to 3, where the channel substance was not used, are described below.

### Reference Example 1

A solution of POPC was prepared by dissolving the phospholipid in chloroform. After the organic solvent had been evaporated under a reduced pressure, pure water was added to the dried lipid thin-membrane remaining in the container and hydration was subsequently performed at 35° C. Hereby, a vesicle dispersion was prepared. The vesicle dispersion was subjected to a freezing and thawing method, in which the vesicle dispersion was immersed in liquid nitrogen and a water bath having a temperature of 35° C. alternately 5 times in order to grow the particles. The vesicle dispersion was then subjected to extrusion sizing through a polycarbonate track-etched membrane having a pore size of 0.1 μm. The vesicle dispersion was subsequently diluted with pure water to a lipid concentration of 0.4 mM.

The membrane main body treated with the silane coupling agent was immersed in the vesicle dispersion for two hours in order to adsorb the phospholipid on the membrane main body. The membrane main body was subsequently ultrasonically washed for ten minutes in order to remove excess phospholipid adsorbed on the membrane main body. Hereby, a POPC-coating membrane was prepared.

### Reference Example 2

A DPPC-coating membrane was prepared as in Reference example 1, except that DPPC was used as a phospholipid instead of POPC. The salt leakage of the DPPC-coating membrane was measured.

### Reference Example 3

A POPC/DPPC-composite-coating membrane was prepared as in Reference examples 1 and 2, except that both POPC and DPPC were used as phospholipids at a ratio of 50/50 (mol %). The salt leakage of the POPC/DPPC-composite-coating membrane was measured.

Table 1 shows the salt leakage of each of the above membranes.

TABLE 1

| | Salt leakage (%) |
|---|---|
| Reference Example 1 | 10 |
| Reference Example 2 | 0.4 |
| Reference Example 3 | 0.6 |

[Discussion]

As shown in Table 1, the salt leaked through the membrane (Reference example 1) including only POPC, which is a phospholipid including an acyl group including an unsaturated fatty acid. This confirms that the phospholipid bilayer was broken by the osmotic pressure and the membrane had insufficient pressure resistance. The amount of salt that leaked through the membrane (Reference example 2) including only DPPC, which is a phospholipid including two acyl groups each constituted by a saturated fatty acid having 16 carbon atoms, and the amount of salt that leaked through the membrane (Reference example 3) including POPC and DPPC as phospholipids were small. This confirms that these membranes have high pressure resistance.

However, as shown in Comparative example 2 below, when the channel substance was added to a membrane (having the composition of the phospholipid used in Reference example 2) including only DPPC, which is a phospholipid including two acyl groups each constituted by a saturated fatty acid having 16 carbon atoms, the quantity of permeate that permeated through the membrane was not sufficiently large.

Comparative examples 1 and 2 which were conducted as in Reference examples 1 and 2 above, respectively, except that the channel substance was used, and Example 1 which was conducted as in Reference example 3 above except that the channel substance was used are described below.

### Comparative Example 1

A GA-containing POPC-coating membrane was prepared as in Reference example 1, except that the channel substance was added to the phospholipid. A quantity of permeate that permeated through the GA-containing POPC-coating membrane was measured.

Specifically, POPC and GA were dissolved in a mixed solvent of chloroform and methanol to prepare a solution in which POPC/GA=95/5 (mol %). A GA-containing POPC-coating membrane was prepared as in Reference example 1, except that the above solution was used. A quantity of permeate that permeated through the GA-containing POPC-coating membrane was measured.

### Comparative Example 2

A GA-containing DPPC-coating membrane was prepared as in Reference example 2, except that the channel substance was added to the phospholipid. A quantity of permeate that permeated through the GA-containing DPPC-coating membrane was measured.

Specifically, DPPC and GA were dissolved in a mixed solvent of chloroform and methanol to prepare a solution in which DPPC/GA=95/5 (mol %). A GA-containing DPPC-coating membrane was prepared as in Reference example 2, except that the above solution was used. A quantity of permeate that permeated through the GA-containing DPPC-coating membrane was measured.

### Example 1

A GA-containing POPC/DPPC-coating membrane was prepared as in Reference example 3, except that the channel substance was added to the phospholipids. A quantity of permeate that permeated through the GA-containing POPC/DPPC-coating membrane was measured.

Specifically, POPC, DPPC, and GA were dissolved in a mixed solvent of chloroform and methanol to prepare a solution in which POPC/DPPC/GA=47.5/47.5/5 (mol %).

### Comparative Example 3

A quantity of permeate that permeated through a commercial FO membrane (produced by Hydration Technology Innovation) was measured.

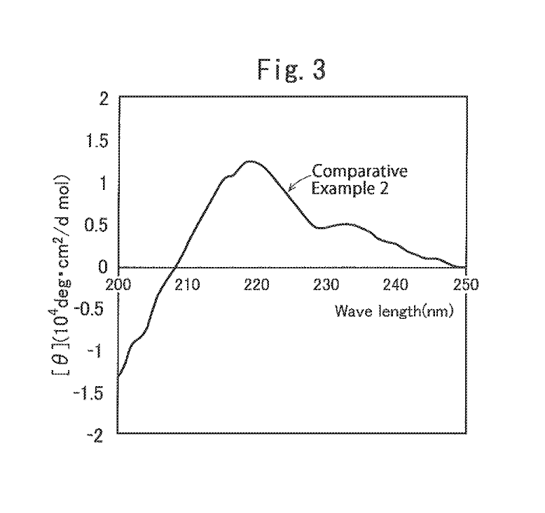

Table 2 shows the results of measurement of the quantity of permeate that permeated through each of the above membranes. FIGS. 2 and 3 illustrate the results of measurement of the CD spectra of the membranes prepared in Comparative examples 1 and 2 and Example 1.

TABLE 2

| | Quantity of permeate |
|---|---|
| | (×10⁻¹²m³m⁻²s⁻¹Pa⁻¹) |
| Comaparative Exampe 1 | 259.5 |
| Comaparative Exampe 2 | 0.14 |
| Comaparative Exampe 3 | 2.24 |
| Exampe 1 | 37.5 |

[Discussion]

The results of the measurement of the CD spectra confirm that gramicidin A formed a channel structure in the membrane (Comparative example 1) including only POPC, which is a phospholipid including an acyl group including an unsaturated fatty acid, and in the membrane (Example 1) including POPC and DPPC as phospholipids. Although a large quantity of permeate was confirmed in Comparative example 1, the pressure resistance of the phospholipid bilayer was not sufficient as shown in Reference example 1.

In the CD spectrum of the membrane (Comparative example 2) including only DPPC, which is a phospholipid including two acyl groups each constituted by a saturated fatty acid having 16 carbon atoms, a valley did not occur at 230 nm. Thus, gramicidin A did not form a channel structure in this membrane. Accordingly, the quantity of permeate that permeated through the membrane was considerably low, that is, specifically, 1/16 the quantity of permeate that permeated through the commercial membrane (Comparative example 3). In contrast, the quantity of permeate that permeated through the membrane (Example 1) including POPC and DPPC as phospholipids was 16 times or more the quantity of permeate that permeated through the commercial membrane (Comparative example 3). This confirms that a membrane having high permeability and high pressure resistance was produced.

Although the present invention has been described in detail with reference to particular embodiments, it is apparent to a person skilled in the art that various modifications can be made therein without departing from the spirit and scope of the present invention.

The present application is based on Japanese Patent Application No. 2015-042528 filed on Mar. 4, 2015, which is incorporated herein by reference in its entirety.

### REFERENCE SIGNS LIST

1 MEMBRANE
2,3 CONTAINER

1. A permselective membrane comprising a membrane main body having permselectivity and a coating layer disposed on a surface of the membrane main body, the coating layer including a phospholipid bilayer including a channel substance, wherein the phospholipid bilayer includes phospholipids that are a first phospholipid including an acyl group constituted by a fatty acid including an unsaturated fatty acid and a second phospholipid including two acyl groups each constituted by a fatty acid that is a saturated fatty acid having 16 to 24 carbon atoms.

2. The permselective membrane according to claim 1, wherein the ratio of the amount of the second phospholipid to the total amount of the first phospholipid and the second phospholipid is 20% to 80% by mole.

3. The permselective membrane according to claim 1, wherein the first phospholipid is one or more phospholipids selected from 1-palmitoyl-2-oleoyl-sn-glycero-3-phosphocholine, 1,2-dioleoyl-sn-glycero-3-phosphocholine, 1,2-dioleoyl-sn-glycero-3-phosphoethanolamine, 1,2-dioleoyl-sn-glycero-3-phospho-L-serine, 1,2-dioleoyl-sn-glycero-3-phospho-rac-(1-glycerol), egg-yolk phosphatidylcholine, and soybean phosphatidylcholine, and wherein the second phospholipid is one or more phospholipids selected from 1,2-dipalmitoyl-sn-glycero-3-phosphocholine, 1,2-diheptadecanoyl-sn-glycero-3-phosphocholine, 1,2-distean ROyl-sn-glycero-3-phosphocholine, 1,2-dinonadecanoyl-sn-glycero-3-phosphocholine, 1,2-diarachidoyl-sn-glycero-3-phosphocholine, 1,2-dibehenoyl-sn-glycero-3-phosphocholine, 1,2-ditricosanoyl-sn-glycero-3-phosphocholine, 1,2-dilignoceroyl-sn-glycero-3-phosphocholine, 1,2-dipalmitoyl-sn-glycero-3-phosphoethanolamine, 1,2-dipalmitoyl-sn-glycero-3-phospho-L-serine, 1,2-dipalmitoyl-sn-glycero-3-phospho-rac-(1-glycerol), hydrogenated egg-yolk phosphatidylcholine, and hydrogenated soybean phosphatidylcholine.

4. The permselective membrane according to claim 1, wherein the first phospholipid is palmitoyloleoylphosphatidylcholine, and wherein the second phospholipid is 1,2-dipalmitoyl-sn-glycero-3-phosphocholine or 1,2-distean ROyl-sn-glycero-3-phosphocholine.

5. The permselective membrane according to claim 1, wherein the channel substance is gramicidin or amphotericin B.

6. The permselective membrane according to claim 1, wherein the ratio of the amount of the channel substance to the total amount of the first phospholipid, the second phospholipid, and the channel substance is 1% to 20% by mole.

7. The permselective membrane according to claim 1, wherein the membrane main body is an MF membrane, a UF membrane, an NF membrane, or an RO membrane.

8. A method for producing a permselective membrane, the method comprising bringing a phospholipid-containing liquid containing phospholipids and a channel substance into contact with a membrane main body in order to form a coating layer including a phospholipid bilayer on a surface of the membrane main body,
wherein the phospholipid-containing liquid contains a first phospholipid including an acyl group constituted by a fatty acid including an unsaturated fatty acid and a second phospholipid including two acyl groups each constituted by a fatty acid that is a saturated fatty acid having 16 to 24 carbon atoms.

9. The method for producing a permselective membrane according to claim 8, wherein the ratio of the amount of the second phospholipid to the total amount of the first phospholipid and the second phospholipid is 20% to 80% by mole.

10. A method for treating water, the method comprising treating water to be treated by membrane separation with the permselective membrane according to claim 1.
